(19) United States
(12) Patent Application Publication
(10) Pub. No.: US 2024/0420468 A1
(43) Pub. Date: Dec. 19, 2024

(54) METHODS AND APPARATUS TO DETECT ANOMALIES IN VIDEO DATA

(71) Applicant: Intel Corporation, Santa Clara, CA (US)

(72) Inventors: Jiaxiang Jiang, Santa Clara, CA (US); Omesh Tickoo, Portland, OR (US); Mahesh Subedar, Portland, OR (US); Ibrahima Jacques Ndiour, Chandler, AZ (US)

(73) Assignee: Intel Corporation, Santa Clara, CA (US)

(21) Appl. No.: 18/821,328

(22) Filed: Aug. 30, 2024

(51) Int. Cl. G06V 20/40; G06V 10/25; G06V 10/77

(52) U.S. Cl. CPC G06V 20/46; G06V 10/25; G06V 10/77

(57) ABSTRACT

Methods and apparatus to detect anomalies in video data are disclosed. An example apparatus disclosed herein generates a reconstructed feature vector corresponding to an input feature vector representative of a video segment, the reconstructed feature vector based on a transformation applied to the input feature vector and an inverse of the transformation applied to an output of the transformation, the input feature vector and the reconstructed feature vector including features associated with a plurality of dimensions including a time dimension. The disclosed example apparatus also generates an error vector based on a difference between the input feature vector and the reconstructed feature vector. The disclosed example apparatus further generates an anomaly map based on sums of elements of the error vector across at least the time dimension, the anomaly map corresponding to the video segment.

### BACKGROUND

Many industries utilize video anomaly detection (VAD) techniques to analyze video data. For example, video surveillance systems can utilize these techniques to monitor busy areas (e.g., roads, airports, etc.). In some examples, VAD techniques aid in mitigating erratic and/or risky behavior.

### BRIEF DESCRIPTION OF THE DRAWINGS

FIG. 1 is a block diagram of an example environment in which example video assessment circuitry operates to detect anomalies in video data.

FIG. 2 is a schematic diagram of an example implementation of the example video assessment circuitry of FIG. 1.

FIG. 3 illustrates an example first sequence of video segments and example corresponding anomaly maps.

FIG. 4 illustrates an example second sequence of video segments and example corresponding anomaly maps.

FIG. 5 illustrates an example third sequence of video segments and example corresponding anomaly maps.

FIG. 6 illustrates an example fourth sequence of video segments and examples corresponding anomaly maps.

FIG. 7 is a flowchart representative of example machine readable instructions and/or example operations that may be executed, instantiated, and/or performed by example programmable circuitry to implement the video assessment circuitry of FIG. 1.

FIG. 8 is a block diagram of an example processing platform including programmable circuitry structured to execute, instantiate, and/or perform the example machine readable instructions and/or perform the example operations of FIG. 7 to implement the video assessment circuitry of FIG. 1.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIG. 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Video anomaly detection (VAD) serves to discern rare and/or irregular incidents occurring within video streams. Given the omnipresence of camera systems and the exponential growth in visual data creation, this capability can provide helpful video analytics and/or enable a diverse set of applications in generative artificial intelligence (AI), graphics and pixel art (e.g. automated spotting of visual artifacts in generated video content), security/defense (e.g., intelligent monitoring), manufacturing, healthcare, biomedical (e.g., deviations from protocols/compliance regulations), etc.

Traditional VAD methods rely on handcrafted features for anomaly detection such as flows (e.g., trajectories) between frames, histogram of flows, foreground segmentation mask, etc. In some examples, these methods have relied on deep learning. In some examples, these methods utilize autoencoders to reconstruct video frames. One example approach restores video events using video frames which are predicted by key frames in the video sequence. Another example method utilizes a hierarchical approach to detect/localize anomalies first at the video level, then in the time dimension. Yet another example approach provides bounding box locations to localize the anomaly regions. In some examples, generative models provide anomaly segmentations on videos.

However, existing VAD methods operate as a black box. For example, existing VAD methods output binary labels for each video frame, leaving a void in understanding the rationale behind their frame-level determinations. In addition, many approaches rely on semi-supervised frameworks that necessitate high-level video annotations and/or supplementary contextual cues, which can swiftly become unfeasible owing to the scarcity of abnormal video data during the training phase. In some examples, such techniques encounter difficulties extrapolating to unknown anomaly types.

Further, previous methods relying on handcrafted features may be unreliable as these handcrafted features are highly subjective and dataset-dependent. Autoencoder-based methods lack localization information in the latent space representation and, thus, those methods are effective in detecting anomalies but may have poor performance in localizing or segmenting anomalies. In some examples, previous methods are limited by reliance on prior information about anomaly types in the dataset. Previous methods may include an estimated location of the anomalies with bounding box locations, but still lack pixel-level segmentation masks. The example techniques that rely on expensive generative models are computationally complex and/or require substantial memory.

Examples disclosed herein provide unsupervised video anomaly segmentation (UVAS). Disclosed examples detect the anomalies temporally (e.g., temporal detection). Further, disclosed examples provide pixel-level anomaly segmentation for a video frame. As such, disclosed examples provide both anomaly detection and segmentation at the video frame level. Examples disclosed herein utilize uncertainty estimation techniques to enable the temporal detection of anomalies within untrimmed videos at the frame level and spatial segmentation within the video frame at the pixel level. Examples disclosed herein are model-agnostic. As such, disclosed examples are usable with various pretrained networks including transformers.

Examples disclosed herein improve the accuracy of generative AI models, animations, and computer-generated imagery (CGI) in identifying anomalies in video data. Examples disclosed herein aid in identifying real-time trespassing, theft, violence, vandalism, and/or other suspicious activities that pose safety risks (e.g., unattended baggage, overcrowding, individuals exhibiting erratic behavior, etc.). Example disclosed herein are usable in industrial settings to detect abnormalities in manufacturing processes, machinery malfunctions, safety hazards, etc. As such, disclosed examples limit and/or prevent accidents, equipment downtime, process downtime, etc. Further, disclosed examples aid in quality control by identifying defective products, deviations from standard production processes, etc. Examples disclosed herein aid in healthcare industries by monitoring personnel, patient behavior, activity patterns, etc. Further, disclosed examples aid in detecting medical occurrences such as falls, seizers, abnormal vital signs, etc. Examples disclosed herein aid in transportation, urban planning, etc., by monitoring traffic flow, detecting accidents, identifying traffic violations, etc. As such, disclosed examples improve traffic management. Examples disclosed herein aid in retail environments by detecting unusual behaviors such as shoplifting, loitering, or queue congestion. As such, disclosed examples provide insights for store layouts, staffing levels, security measures, etc. Further, examples disclosed herein aid in environmental monitoring applications (e.g., wildlife conservation, forest fire detection, etc.) to identify abnormal events such as, for example, poaching illegal logging, natural disasters, erratic animal behavior, etc.

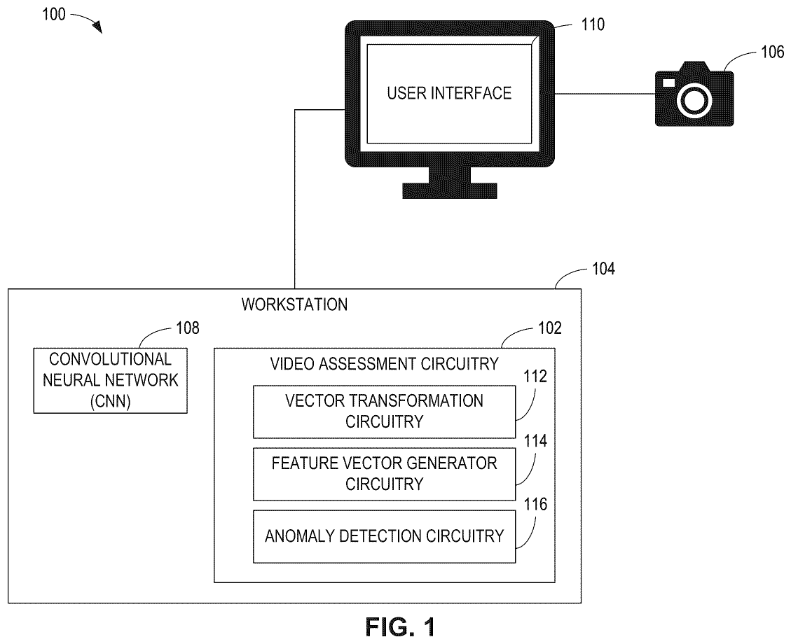

FIG. 1 is a block diagram of an example environment 100 in which example video assessment circuitry 102 operates to detect anomalies in video data. The example environment 100 includes an example workstation 104 coupled to an example camera 106. The example camera 106 provides video data to the example workstation 104. In some examples, the camera 106 captures, senses and/or records activity and, in turn, stores the recorded activity as video data. In some examples, the camera 106 is positioned adjacent a busy road and records traffic activity (e.g., pedestrian behavior, car movement, etc.). In some examples, the camera is positioned in an airport and records airport activity (e.g., plane movement, passenger behavior, baggage, etc.).

The example workstation 104 implements the example video assessment circuitry 102 to assess, process, etc., the video data provided by the camera 106. In the example of FIG. 1, the workstation 104 implements an example convolutional neural network (CNN) 108 to extract features from the video data. For example, the CNN 108 (e.g., Extensible Three Dimensional (X3D), Inflated Three Dimensional (I3D), R(2+1)D, etc.) performs spatio-temporal feature extraction on the video data. In some examples, the workstation 104 implements a transformer (e.g., Shifted Window Three Dimensional (Swin3D)) to extract features from the video data. In some examples, the workstation 104 implements any 3D backbone for spatio-temporal feature extraction. The example workstation 104 includes an example user interface (UI) 110 to display the video data and/or outputs of the video assessment circuitry 102. For example, the video assessment circuitry 102 displays anomaly maps associated with the video data on the UI 110. In some examples, an operator of the workstation 104 can determine and/or perform remedial actions based on the video data, the anomaly maps, etc.

The example video assessment circuitry 102 includes example vector transformation circuitry 112, example feature vector generator circuitry 114, and example anomaly detection circuitry 116. The example video assessment circuitry 102 of FIG. 1 may be instantiated (e.g., creating an instance of, bring into being for any length of time, materialize, implement, etc.) by programmable circuitry such as a Central Processor Unit (CPU), a Graphic Processor Unit (GPU), or a Neural Processor Unit (NPU) executing first instructions. Additionally or alternatively, the example video assessment circuitry 102 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example feature vector generator circuitry 114 generates an input feature vector based on features associated with a video segment (e.g., a segment of the video data provided by the camera 106). The example video data provided by the example camera 106 includes multiple video segments. As disclosed in further detail below, a given input feature vector includes features generated by the CNN 108 from a given video segment of the video data. The example input feature vector includes features associated with a plurality of dimensions including a time dimension. In some examples, the input feature vector includes features associated with a channel dimension. For example, the channel dimension can include one (1) channel (e.g., C=1) for grayscale image/video data (e.g., which would correspond to a grayscale channel), three (3) channels (e.g., C=3) for color image/video data (e.g., such as red-green-blue or RGB data, which would correspond to a red channel, a green channel and a blue channel), or an arbitrary number of channels (e.g., C) for other multi-spectral image/video data. Further, the example plurality of dimensions includes one or more spatial dimensions (e.g., such as a width dimension and a height dimension). As such, the example plurality of dimensions includes one or more of the time dimension, the channel dimension, the width dimension and the height dimension.

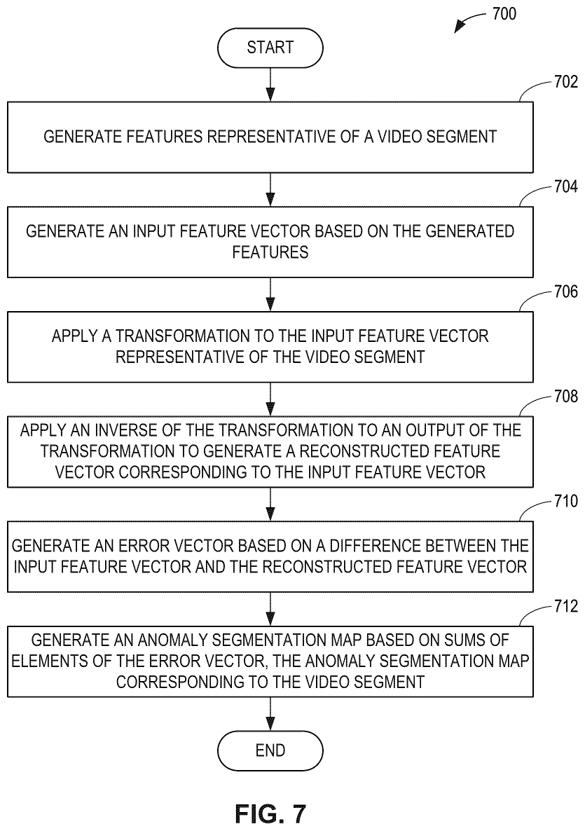

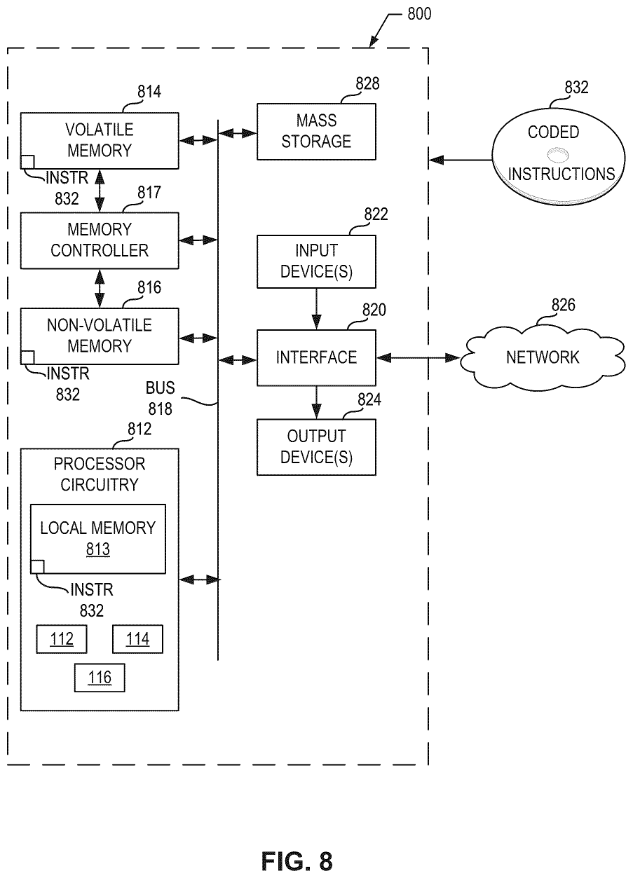

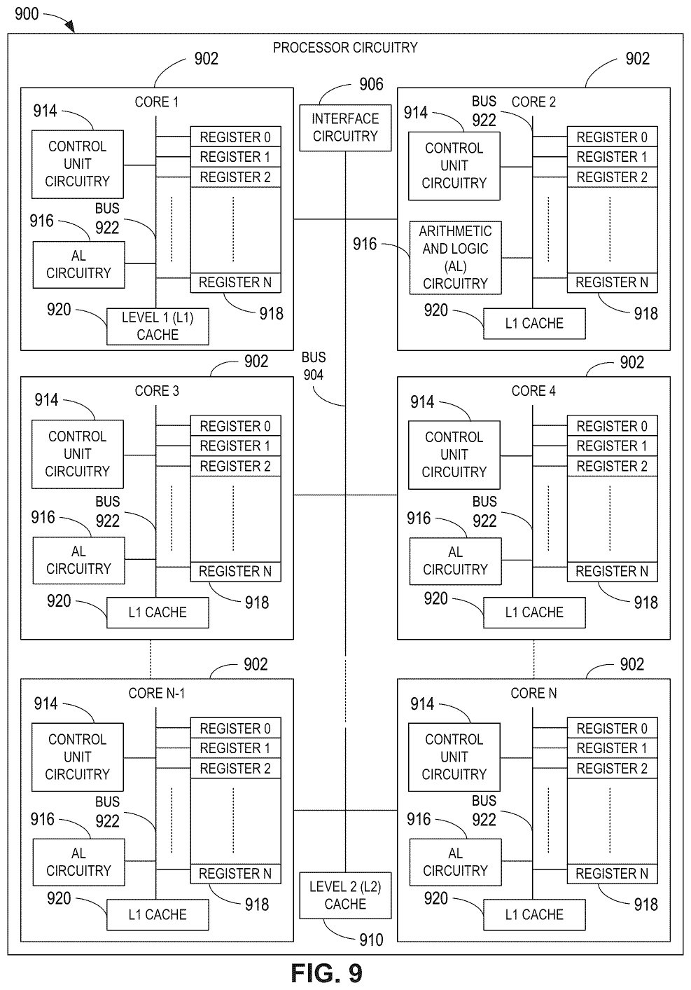

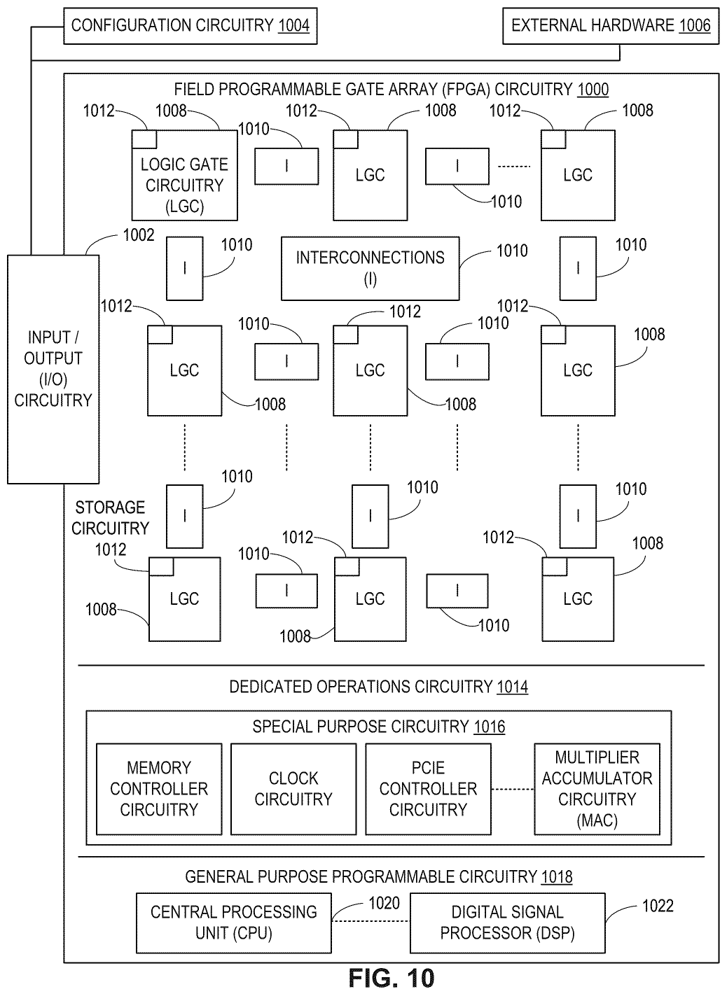

In some examples, the feature vector generator circuitry 114 is instantiated by programmable circuitry executing feature vector generation instructions and/or configured to perform operations such as those represented by the flowchart of FIG. 7. In some examples, the video assessment circuitry 102 includes means for generating a feature vector. For example, the means for generating may be implemented by feature vector generator circuitry 114. In some examples, the feature vector generator circuitry 114 may be instantiated by programmable circuitry such as the example programmable circuitry 812 of FIG. 8. For instance, the feature vector generator circuitry 114 may be instantiated by the example microprocessor 900 of FIG. 9 executing machine executable instructions such as those implemented by at least blocks 704 of FIG. 7. In some examples, the feature vector generator circuitry 114 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the feature vector generator circuitry 114 may be instantiated by any other combination of hardware, software, and/or firmware. For example, the feature vector generator circuitry 114 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

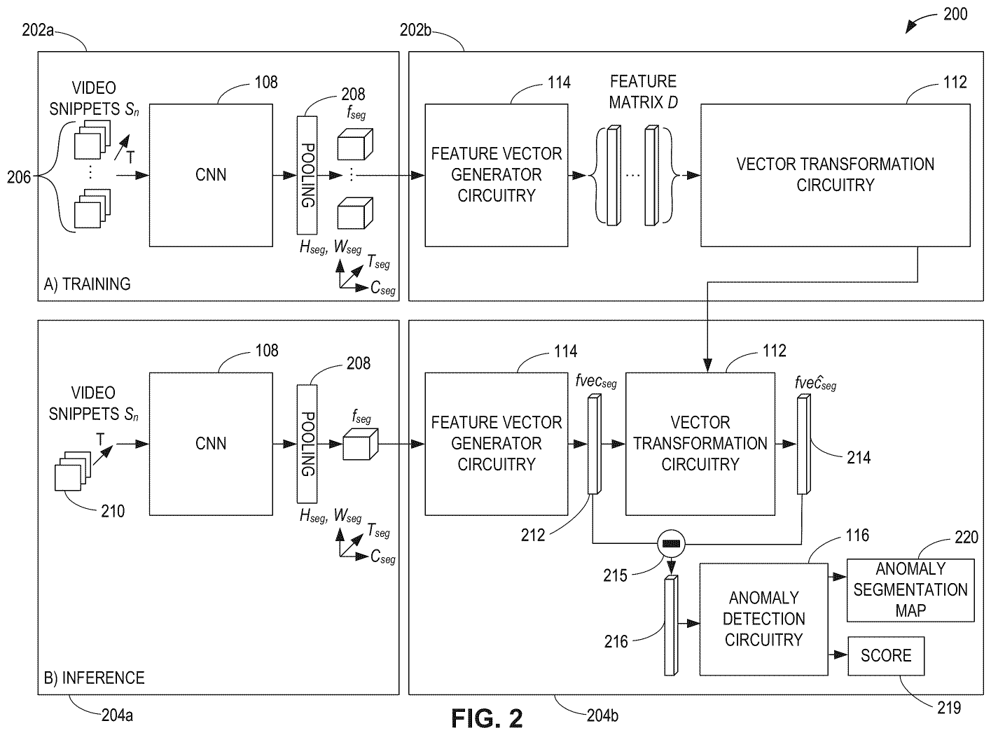

The example vector transformation circuitry 112 applies a transformation to the input feature vector representative of the video segment. The example vector transformation circuitry 112 also applies an inverse of the transformation to an output of the transformation of the input feature vector to generate a reconstructed feature vector corresponding to the input feature vector. The example reconstructed feature vector includes features associated with a plurality of dimensions including the time dimension. In some examples, the reconstructed feature vector includes features associated with the channel dimension. In some examples, the reconstructed feature vector includes features associated with one or more spatial dimensions (e.g., such as a width dimension and a height dimension). In some examples, the transformation is based on a dimensionality reduction model, as described in detail in connection with at least FIG. 2. In some examples, the dimensionality reduction model is based on Principal Component Analysis (PCA). In some examples, the inverse transformation corresponds to an inverse of the dimensionality reduction model.

In some examples, the vector transformation circuitry 112 is instantiated by programmable circuitry executing vector transformation instructions and/or configured to perform operations such as those represented by the flowchart of FIG. 7. In some examples, the video assessment circuitry 102 includes means for transforming a vector. For example, the means for transforming may be implemented by vector transformation circuitry 112. In some examples, the vector transformation circuitry 112 may be instantiated by programmable circuitry such as the example programmable circuitry 812 of FIG. 8. For instance, the vector transformation circuitry 112 may be instantiated by the example microprocessor 900 of FIG. 9 executing machine executable instructions such as those implemented by at least blocks 706, 708 of FIG. 7. In some examples, the vector transformation circuitry 112 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the vector transformation circuitry 112 may be instantiated by any other combination of hardware, software, and/or firmware. For example, the vector transformation circuitry 112 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example anomaly detection circuitry 116 generates an error vector based on a difference between the input feature vector and the reconstructed feature vector. Further, the example anomaly detection circuitry 116 generates an anomaly map based on sums of elements of the error vector across the time dimension, the anomaly map corresponding to the video segment. In some examples, the anomaly map includes (e.g., indicates, emphasizes, etc.) regions of interest in the video segment. In some examples, the anomaly detection circuitry 116 displays the anomaly map on the UI 110 of the workstation 104. In some examples, the anomaly detection circuitry 116 generates the anomaly map based on sums of the elements of the error vector across both the time dimension and the channel dimension. In some examples, the anomaly map includes entries associated with the height dimension and the width dimension.

In some examples, the anomaly detection circuitry 116 is instantiated by programmable circuitry executing anomaly detection instructions and/or configured to perform operations such as those represented by the flowchart of FIG. 7. In some examples, the video assessment circuitry 102 includes means for detecting an anomaly. For example, the means for detecting may be implemented by anomaly detection circuitry 116. In some examples, the anomaly detection circuitry 116 may be instantiated by programmable circuitry such as the example programmable circuitry 812 of FIG. 8. For instance, the anomaly detection circuitry 116 may be instantiated by the example microprocessor 900 of FIG. 9 executing machine executable instructions such as those implemented by at least blocks 710, 712 of FIG. 7. In some examples, the anomaly detection circuitry 116 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the anomaly detection circuitry 116 may be instantiated by any other combination of hardware, software, and/or firmware. For example, the anomaly detection circuitry 116 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 2 is a schematic diagram 200 of an example implementation of the example video assessment circuitry 102 of FIG. 1. The example schematic diagram 200 includes example training phases 202a, 202b and example inference phases 204a, 204b. During the example training phase 202a, the CNN 108 divides the video data provided by the example camera 106 into a set of video segments 206 (e.g., fixed length video segments). In some examples, the video segments 206 include a training dataset having known localized anomalies and known normal patterns (e.g., lacking anomalies) in example segments. As used herein, the terms “video segment,” “segment,” and “video snippet” are used interchangeably. Example Equation (1) below denotes the input video sequence Vᵢₙₚᵤₜ divided into a number (N) of video segments.

$${V}_{input} = {Sn}_{i} ; \qquad ( 1 )$$

$$i ∈ \{ 1 , 2 , … , N \}$$

In some examples, the video segments 206 are denoted as shown in example Equation (2) below. In example Equation (2), (N) denotes the total number of video segments in the video data.

$$V = \{ {V}_{1} , {V}_{2} , … {V}_{N} \} \qquad ( 2 )$$

During the example training phase 202a, the example CNN 108 extracts spatio-temporal features from the video segments. For example, the CNN 108 extracts spatial features (e.g., height features, width features) from each of the video segments, temporal features (e.g., time features) from each of the video segments, and channel features from each of the video segments. In some examples, the feature vector generator circuitry 114 executes an example pooling operation (block 208) to associate the features with the segments. Example Equation (3) below is a formulaic representation of this association.

$${f}_{seg}^{i} ∈ {R}^{{C}_{seg} \times {T}_{seg} \times {H}_{seg} \times {W}_{seg}} \qquad ( 3 )$$

Equation (3) represents a set of spatio-temporal features that are indexed by spatial dimensions H and W, a time dimension T, and a channel dimension C, and take on real number values. For a given combination of indices of the dimensions H, W, T, C, there is a real number value of the feature. During the example training phase 202b, the feature vector generator circuitry 114 vectorizes the extracted features from the training phase 202a. In other words, the example feature vector generator circuitry 114 arranges the values of the features for each segment in corresponding vectors (fvec_{seg}ⁱ). For example, an example feature vector for a first video segment of the video segments is denoted as fvec_{seg}¹.

Further, as shown in example Equation (4), the feature vectors corresponding to each of the video segments can be arranged in a feature matrix (D). The example feature matrix (D) is rank deficient because of high-dimensional feature representation in the latent space. As such, the example feature matrix (D) is associated with a high dimensional space. As used herein, the term “high dimensional space” refers to a size of the multidimensional space associated with the features of the feature vectors, such as the size of the four dimensions (e.g., time, height, width, and channel), which corresponds to C_{seg}×T_{seg}×H_{seg}×W_{seg} of Equation (3). However, the example high dimensional space can have any number of dimensions (e.g., 3, 5, 6, etc.).

$$D = [ {fvec}_{seg}^{1} , {fvec}_{seg}^{2} , … , {fvec}_{seg}^{N} ] \qquad ( 4 )$$

During the example training phase 202a, the example vector transformation circuitry 112 accesses the feature matrix (D) of Equation (4) to train a transformation to reduce the dimensionality of the feature matrix (D). For example, the vector transformation circuitry 112 generates (e.g., trains) a transformation to map (e.g., transform) at least one of the feature vectors (e.g., fvec_{seg}⁰) into a lower dimensional subspace (W). As shown in Equation (5) below, the dimensionality of the example subspace (W) is much smaller than the high dimensional space associated with feature matrix (D). In some examples, after the vector transformation circuitry 112 completes training of the transformation, the subspace (W) captures (e.g., represents) normal (e.g., expected) patterns in the example video data.

$$dim ( W ) ≪ {C}_{seg} \times {T}_{seg} \times {H}_{seg} \times {W}_{seg} \qquad ( 5 )$$

The example vector transformation circuitry 112 determines the example transformation during the training phase 202b by collecting eigenvectors corresponding to the largest dim (W) eigenvalues of the Singular Value Decomposition (SVD) of the feature matrix (D). The example collected eigenvectors form the basis for the subspace (W). Therefore, the example collected eigenvectors map the feature vectors (e.g., fvec_{seg}ⁱ) to subspace (W). The example vector transformation circuitry 112 utilizes PCA to model the transformation. The example vector transformation circuitry 112 determines the inverse of the transformation based on the Moore-Penrose pseudo-inverse of the forward transformation.

The example inference phase 204a is similar to the example training phase 202a. For example, the CNN 108 divides the video data into example video segments 210 (Equation (1) and Equation (2)), the CNN 108 extracts features from each segment, the feature vector generator circuitry 114 associates the extracted features with the corresponding segments (Equation (3)), and the feature vector generator circuitry 114 vectorizes the extracted features by video segment (fvec_{seg}ⁱ). The example video assessment circuitry 102 selects an example vector of interest (fvec_{seg}) 212 to scan/assess for anomalies. In some examples, the selected vector (fvec_{seg}) 212 is referred to herein as the input feature vector 212. The example selected vector (fvec_{seg}) 212 is associated with the high dimensional space (e.g., having four dimensions). The example vector transformation circuitry 112 applies the transformation (determined during the training phase 202b) to the selected vector (fvec_{seg}) 212 to determine a low dimensional vector. Example Equation (6) below indicates that this reduced dimension version of the selected vector (fvec_{seg}) 212, as denoted by (femb_{seg}), is an element of the low dimensional subspace (W).

$${femb}_{seg} ∈ W \qquad ( 6 )$$

As such, femb_{seg} can be referred to as an output of the transformation. In turn, the vector transformation circuitry 112 applies the inverse of the transformation to the output (e.g., femb_{seg}) of the transformation to generate an example reconstructed feature vector (f [symbol] _{seg}) 214. As previously mentioned, the subspace (W) includes normal patterns in example video data. Further, the example vector transformation circuitry 112 reduced the dimensionality of the selected vector (fvec_{seg}) 212 such that the output femb_{seg} corresponds to the subspace (W), and the reconstructed feature vector (f [symbol] _{seg}) 214 correspond to the original multidimensional feature space (e.g., C_{seg}×T_{seg}×H_{seg}×W_{seg}). Therefore, the example reconstructed feature vector (f [symbol] _{seg}) 214 represents normal (e.g., expected) patterns in the input video data, which are learned during training with the training video distribution.

The example anomaly detection circuitry 116 includes or utilizes example error computation circuitry 215 that generates an example error vector 216 based on a difference between the selected vector (fvec_{seg}) 212 and the reconstructed feature vector (f [symbol] _{seg}) 214. In some examples, the anomaly detection circuitry 116 determines the error vector 216 based on an element-wise mean squared difference between the selected vector (fvec_{seg}) 212 and the reconstructed feature vector (f [symbol] _{seg}) 214. In some examples, the video segment associated with the selected vector (fvec_{seg}) 212 includes an anomaly when the selected vector (fvec_{seg}) 212 is different from the reconstructed feature vector (f [symbol] _{seg}) 214. In such examples, the sums of the elements of the error vector 216 does not equal zero (e.g., is greater than zero or less than zero). Alternatively, the video segment associated with the example selected vector (fvec_{seg}) 212 does not include an anomaly when the selected vector (fvec_{seg}) 212 is the same as the reconstructed feature vector (f [symbol] _{seg}) 214. In such examples, the sums of the elements of the error vector 216 equals or is close to zero (e.g., within a tolerance value/threshold of zero, and the tolerance value/threshold may be based on the sizes/magnitudes of the data values in the selected vector (fvec_{seg}) 212 and/or the reconstructed feature vector (f [symbol] _{seg}) 214).

Example Equation (7) below represents temporally localized anomalies. For example, Equation (7) represents a tensor of length T of real numbers that includes an instance of a T dimensional tensor (Det). In other words, the anomaly detection results, as denoted by (Det), are an element of R^{T}. The example anomaly detection circuitry 116 include anomaly score generation circuitry that generates a single scalar value (dᵢ) based on the error vector 216 (e.g., corresponding to or based on the L2 norm of the error vector 216), as shown below in example Equation (8). Further, (dᵢ) below represents an anomaly detection score 219 for the video segment i as a single scalar element of the tensor (Det). In other words, (dᵢ) is an example uncertainty estimate for the video segment i.

$$Det ∈ {R}^{T} \qquad ( 7 )$$

$${d}_{i} ∈ Det \qquad ( 8 )$$

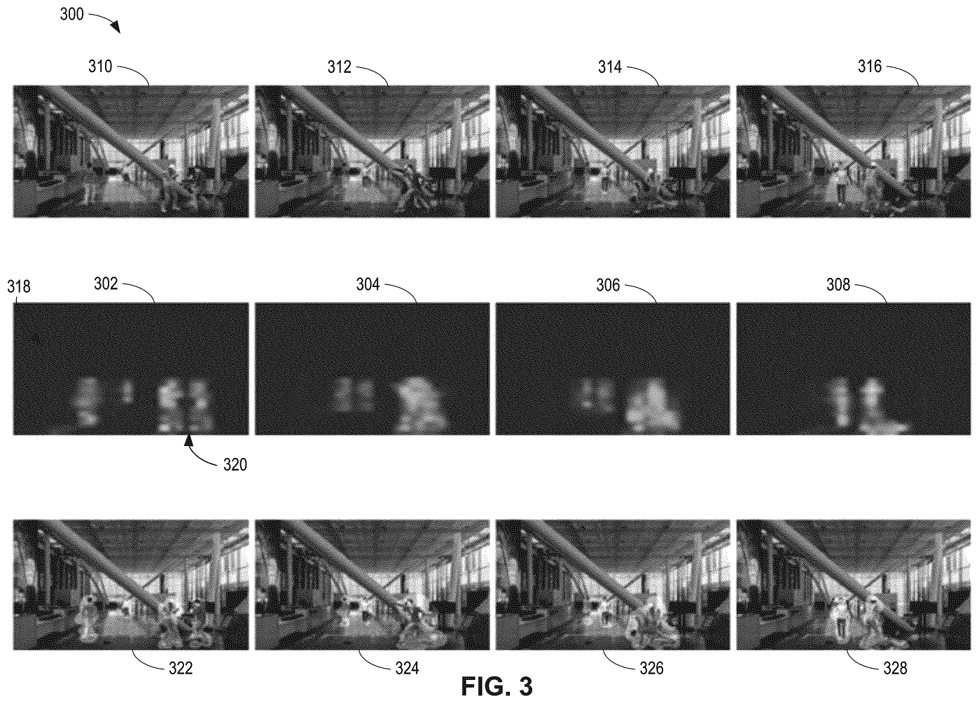

Additionally or alternatively, the example anomaly detection circuitry 116 includes anomaly segmentation circuitry that reshapes the error vector 216 into a higher dimensional space (e.g., to the same spatial size as the input video frames) to generate an example element wise anomaly segmentation map 220 (as illustrated in at least FIGS. 3-6). The example element wise anomaly segmentation map 220 is also referred to herein as “anomaly segmentation map,” “anomaly map,” or “segmentation map.” In some examples, the anomaly segmentation map 220 includes (e.g., indicates, emphasizes, etc.) regions of interest in the video segment. For example, the anomaly segmentation map 220 localizes anomalies in the video data in the time dimension and the spatial dimension. Example Equation (9) below is a formulaic representation of the anomaly localization.

$${V}_{input} ∈ {R}^{T \times C \times H \times W} , ( Det , Seg ) = A ( {V}_{input} ) \qquad ( 9 )$$

In the example Equation (9), (T) denotes the length of the input video data, (H) denotes a first spatial dimension (height), (W) denotes a second spatial dimension (width), (C) denotes the channel dimension, and (A) denotes the implementation of the video assessment circuitry 102 as described in connection with at least FIGS. 1 and 2.

Example Equation (10) below represents a spatially localized map of anomalous regions for each image in a segment. Further, example Equation (10) represents a tensor of three dimensions (e.g., time T, height H, and width W) of real numbers that includes an instance of a three dimensional tensor (Seg). Example Equation (10) represents a map that has been summed across the channel dimension C.

$$Seg ∈ {R}^{T \times H \times W} \qquad ( 10 )$$

The example anomaly detection circuitry 116 (e.g., with its anomaly segmentation circuitry) sums the errors of the error vector 216 across the channel and time dimensions to output the anomaly segmentation map 220 for all the images in the video segment i as shown in example Equations (11) and (12) below. Further, example equation (12) below is a tensor of two dimensions (e.g., height H and width W) of real numbers that includes the two dimensional tensor si. As such, the anomaly segmentation map 220 (as described in connection with Equations (11) and (12)) has the same spatial dimension as the selected vector (fvec_{seg}) 212.

$${s}_{i} ∈ Seg \qquad ( 11 )$$

$${s}_{i} ∈ {R}^{H \times W} \qquad ( 12 )$$

FIG. 3 illustrates an example first sequence 300 of video segments and example corresponding anomaly maps 302, 304, 306, 308. The example video segments represent video data of activity in a transportation center (e.g., an airport). Example images 310, 312, 314, 316 represent ground truth data associated with the video data. As shown in the example anomaly maps 302, 304, 306, 308, the video assessment circuitry 102 localizes anomalies in the video segments. For example, comparing the ground truth images 310, 312, 314, 316 to corresponding ones of the anomaly maps 302, 304, 306, 308 the video assessment circuitry 102 (following the implementation described in at least FIGS. 1 and 2) effectively localizes anomalies in the spatial frames of the video segments. In the example of FIG. 3, the anomalies include human movement (e.g., physical contact, walking, etc.). As shown in FIG. 3, the example anomaly maps 302, 304, 306, 308 are heat maps that emphasize anomalies (e.g., regions of interest) by shading or overlaying color on the anomalies in the frame. For example, the anomaly map 302 includes a first region 318 having a first shade (e.g., color) and a second region 320 having a second shade different from the first shade. In some examples, an amount or level of shading can indicate an anomaly score for a given pixel. As such, the anomaly maps 302, 304, 306, 308 include pixel-wise anomaly scores associated with the first sequence 300.a The example second region 320 includes at least one anomaly. In some examples, any of the anomaly maps 302, 304, 306, 308 are displayed on the UI 110 of the workstation 104.

In some examples, the video assessment circuitry 102 generates example segmentation maps 322, 324, 326, 328 based on the anomaly maps 302, 304, 306, 308. For example, the video assessment circuitry 102 generates the segmentation map 322 by (i) comparing pixels in the anomaly map 302 to a threshold, (ii) generating an example binary map (e.g., a shading map of shaded pixels and unshaded pixels) based on the comparison, and (iii) superimposing (e.g., overlaying) the binary map on the raw video data to indicate the anomalies (e.g., the shaded pixels). In some examples, the threshold is a level or amount of shading applied to a pixel.

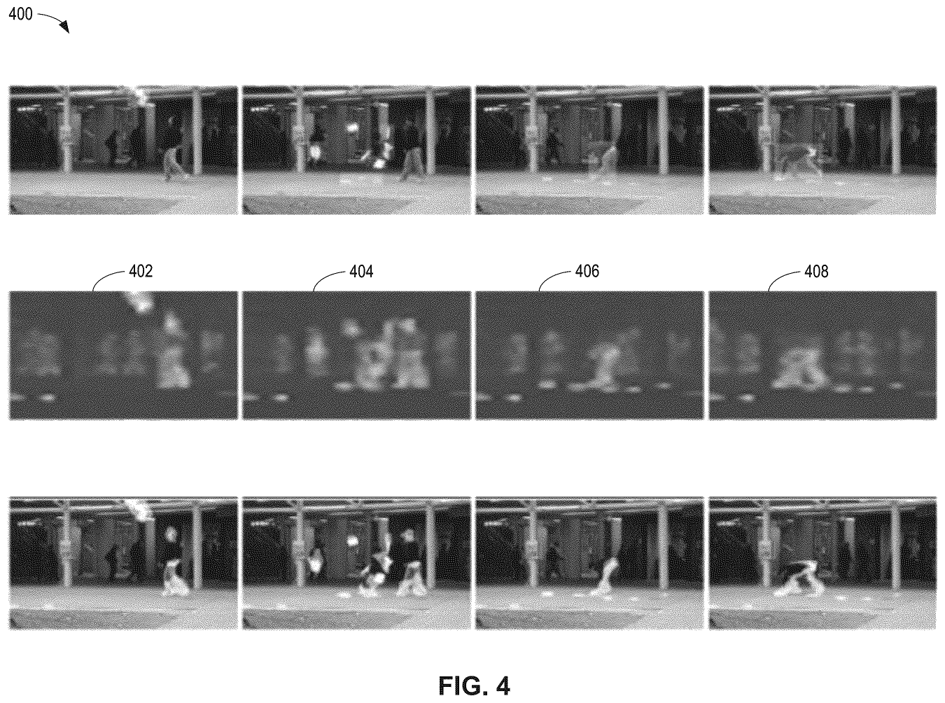

FIG. 4 illustrates an example second sequence 400 of video segments and example corresponding anomaly maps 402, 404, 406, 408. The example second sequence 400 of FIG. 4 is similar to the example first sequence 300 of FIG. 3. However, the video segments associated with the second sequence 400 represent activity on a sidewalk. Similar to the example anomaly maps 302, 304, 306, 308 of FIG. 3, the anomaly maps 402, 404, 406, 408 emphasize anomalies with shading/coloring.

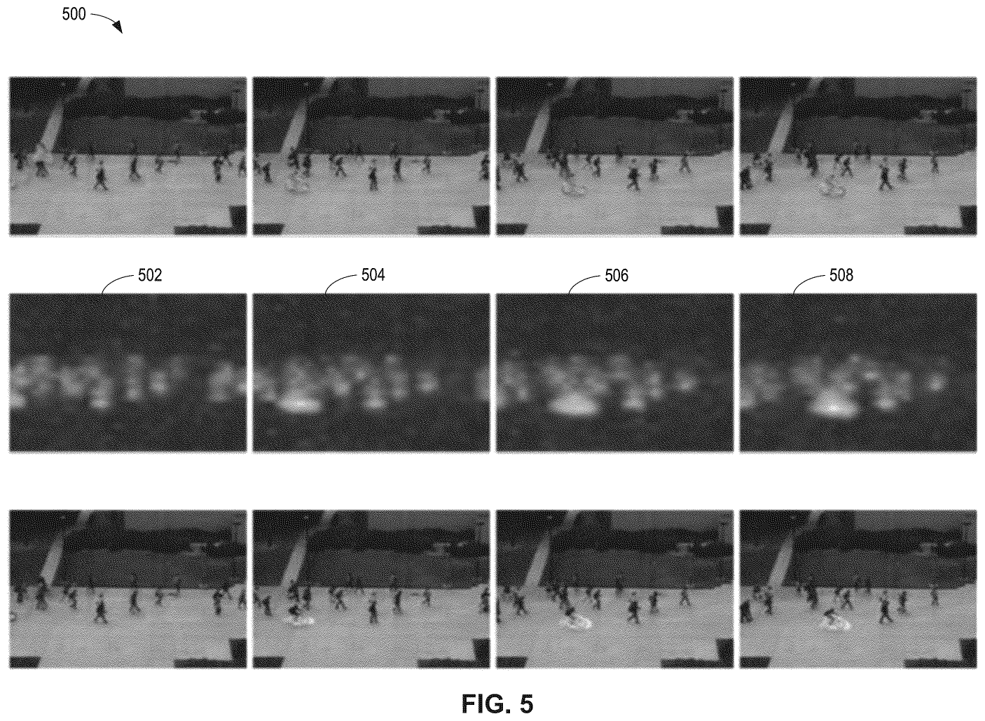

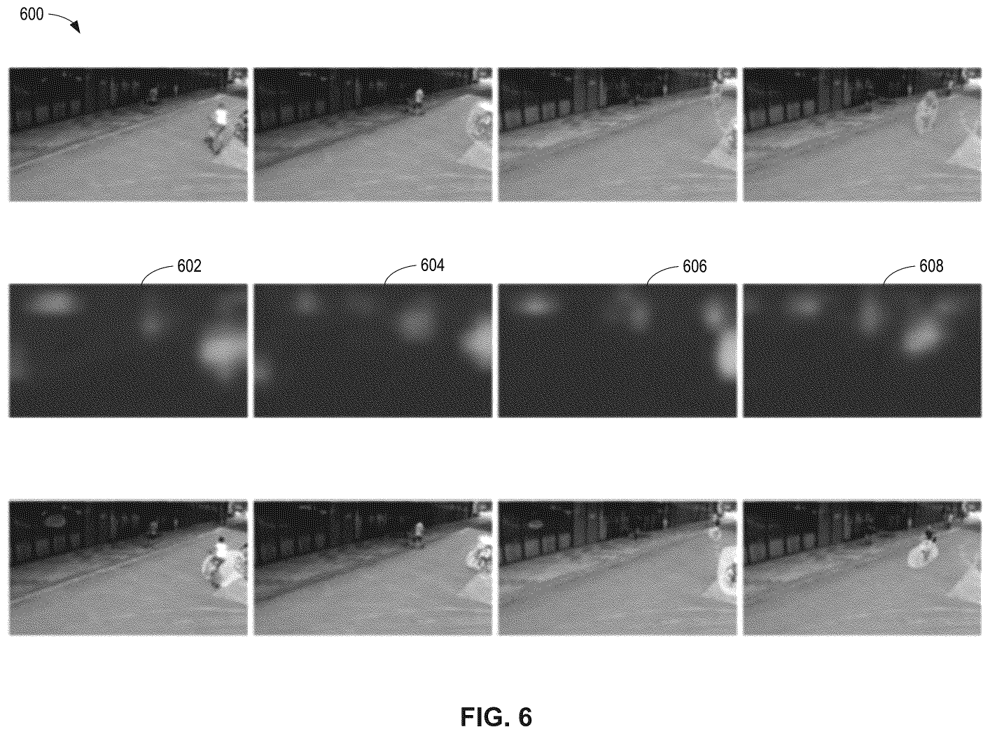

FIG. 5 illustrates an example third sequence 500 of video segments and example corresponding anomaly maps 502, 504, 506, 508. The example third sequence 500 of FIG. 5 is similar to the example second sequence 400 of FIG. 4. For example, the video segments associated with the third sequence 500 represent activity on a sidewalk. FIG. 6 illustrates an example fourth sequence 600 of video segments and examples corresponding anomaly maps 602, 604, 606, 608. The example fourth sequence 600 of FIG. 6 is similar to the example first, second, and third sequences 300, 400, 500 of FIGS. 3-5. However, the video segments associated with the fourth sequence 600 represent activity on a bike path.

While an example manner of implementing the video assessment circuitry 102 of FIG. 1 is illustrated in FIG. 1, one or more of the elements, processes, and/or devices illustrated in FIG. 1 may be combined, divided, re-arranged, omitted, eliminated, and/or implemented in any other way. Further, the example vector transformation circuitry 112, example feature vector generator circuitry 114, example anomaly detection circuitry 116, and/or, more generally, the example video assessment circuitry 102 of FIG. 1, may be implemented by hardware alone or by hardware in combination with software and/or firmware. Thus, for example, any of the example vector transformation circuitry 112, example feature vector generator circuitry 114, example anomaly detection circuitry 116, and/or, more generally, the example video assessment circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example video assessment circuitry 102 of FIG. 1 may include one or more elements, processes, and/or devices in addition to, or instead of, those illustrated in FIG. 1, and/or may include more than one of any or all of the illustrated elements, processes and devices.

A flowchart representative of example machine readable instructions, which may be executed by programmable circuitry to implement and/or instantiate the video assessment circuitry 102 of FIG. 1 and/or representative of example operations which may be performed by programmable circuitry to implement and/or instantiate the video assessment circuitry 102 of FIG. 1, are shown in FIG. 7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 7, many other methods of implementing the example video assessment circuitry 102 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to detect anomalies in video data. The example machine-readable instructions and/or the example operations 700 of FIG. 7 begin at block 702, at which the example CNN 108 generates features representative of a video segment (e.g., a segment of the video data provided by the camera 106). The example video data provided by the example camera 106 includes multiple video segments.

At block 704, the example feature vector generator circuitry 114 generates an input feature vector based on the generated features. For example, the feature vector generator circuitry 114 generates the selected vector (fvec_{seg}) 212 based on the generated features representative of the video segment. The example selected vector (fvec_{seg}) 212 includes features associated with a plurality of dimensions including a time dimension. In some examples, the selected vector (fvec_{seg}) 212 includes features associated with a channel dimension. As such, the example plurality of dimensions includes the channel dimension. Further, the example plurality of dimensions includes a width dimension and a height dimension.

At block 706, the example vector transformation circuitry 112 applies a transformation to the input feature vector (e.g., the selected vector (fvec_{seg}) 212).

At block 708, the example vector transformation circuitry 112 applies an inverse of the transformation to an output (e.g., femb_{seg}) of the transformation to generate a reconstructed feature vector (e.g., the reconstructed feature vector (f [symbol] _{seg}) 214) corresponding to the input feature vector (e.g., the selected vector (fvec_{seg}) 212). In some examples, the transformation is based on a dimensionality reduction model. In some examples, the dimensionality reduction model is based on PCA. In some examples, the inverse transformation corresponds to an inverse of the dimensionality reduction model. The example reconstructed feature vector (f [symbol] _{seg}) 214 includes features associated with a plurality of dimensions including the time dimension. In some examples, the reconstructed feature vector (f [symbol] _{seg}) 214 includes features associated with the channel dimension.

At block 710, the example anomaly detection circuitry 116 generates an error vector (e.g., the error vector 216) based on a difference between the input feature vector (e.g., the selected vector (fvec_{seg}) 212) and the reconstructed feature vector (e.g., the reconstructed feature vector (f [symbol] _{seg}) 214).

At block 712, the example anomaly detection circuitry 116 generates an anomaly map (e.g., the anomaly segmentation map 220) based on sums of elements of the error vector 216 across the time dimension, the anomaly segmentation map 220 corresponding to the video segment. In some examples, the anomaly segmentation map 220 includes regions of interest in the video segment. In some examples, the anomaly detection circuitry 116 displays the anomaly segmentation map 220 on the UI 110 of the workstation 104. In some examples, the anomaly detection circuitry 116 generates the anomaly segmentation map 220 based on sums of the elements of the error vector 216 across both the time dimension and the channel dimension. In some examples, the anomaly map includes entries associated with the height dimension and the width dimension. Then, the process ends.

FIG. 8 is a block diagram of an example programmable circuitry platform 800 structured to execute and/or instantiate the example machine-readable instructions and/or the example operations of FIG. 7 to implement the video assessment circuitry 102 of FIG. 1. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example vector transformation circuitry 112, the example feature vector generator circuitry 114, and the example anomaly detection circuitry 116.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, a camera (still or video).

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIG. 7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowchart of FIG. 7 to effectively instantiate the circuitry of FIG. 1 as logic circuits to perform operations corresponding to those machine readable instructions. In some such examples, the circuitry of FIG. 1 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIG. 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart of FIG. 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart of FIG. 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 7. As such, the FPGA circuitry 1000 may be configured and/or structured to effectively instantiate some or all of the operations/functions corresponding to the machine readable instructions of the flowchart of FIG. 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIG. 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIG. 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart of FIG. 7 to perform first operation(s)/function(s), the FPGA circuitry 1000 of FIG. 10 may be configured and/or structured to perform second operation(s)/function(s) corresponding to a second portion of the machine readable instructions represented by the flowchart of FIG. 7, and/or an ASIC may be configured and/or structured to perform third operation(s)/function(s) corresponding to a third portion of the machine readable instructions represented by the flowchart of FIG. 7.

It should be understood that some or all of the circuitry of FIG. 1 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 1 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

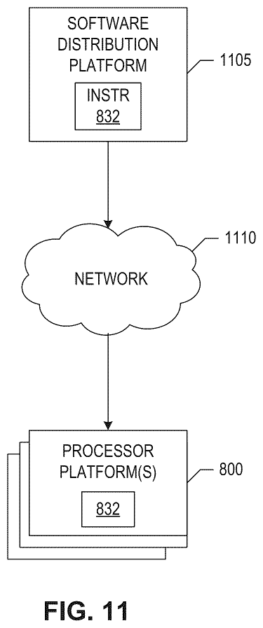

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIG. 7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 7, may be downloaded to the example programmable circuitry platform 800, which is to execute the machine readable instructions 832 to implement the video assessment circuitry 102. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide unsupervised video anomaly segmentation. Disclosed examples detect the anomalies temporally (e.g., temporal detection). Further, disclosed examples provide pixel-level anomaly segmentation for each video frame. As such, disclosed examples provide both anomaly detection and segmentation at each video frame. Examples disclosed herein utilize uncertainty estimation techniques to enable the temporal detection of anomalies within untrimmed videos at the frame level and spatial segmentation within the video frame at the pixel level. Disclosed systems, apparatus, articles of manufacture, and methods improve the efficiency of using a computing device by improving the accuracy of generative AI models, animations, and computer-generated imagery (CGI) in identifying anomalies in video data. Disclosed systems, apparatus, articles of manufacture, and methods are accordingly directed to one or more improvement(s) in the operation of a machine such as a computer or other electronic and/or mechanical device.

Example 1 includes an apparatus comprising interface circuitry, machine-readable instructions, and at least one processor circuit to be programmed by the machine-readable instructions to generate a reconstructed feature vector corresponding to an input feature vector representative of a video segment, the reconstructed feature vector based on a transformation applied to the input feature vector and an inverse of the transformation applied to an output of the transformation, the input feature vector and the reconstructed feature vector including features associated with a plurality of dimensions including a time dimension, generate an error vector based on a difference between the input feature vector and the reconstructed feature vector, and generate an anomaly map based on sums of elements of the error vector across at least the time dimension, the anomaly map corresponding to the video segment.

Example 2 includes the apparatus of example 1, wherein the anomaly map indicates regions of interest in the video segment.

Example 3 includes the apparatus of example 1, wherein the plurality of dimensions include a channel dimension, and one or more of the at least one processor circuit is to generate the anomaly map based on sums of the elements of the error vector across both the time dimension and the channel dimension.

Example 4 includes the apparatus of example 3, wherein the plurality of dimensions include a height dimension and a width dimension, the anomaly map including entries associated with the height dimension and the width dimension.

Example 5 includes the apparatus of example 1, wherein the transformation is based on a dimensionality reduction model.

Example 6 includes the apparatus of example 5, wherein the dimensionality reduction model is based on Principal Component Analysis (PCA).

Example 7 includes the apparatus of example 5, wherein the inverse of the transformation corresponds to an inverse of the dimensionality reduction model.

Example 8 includes At least one non-transitory machine-readable medium comprising machine-readable instructions to cause at least one processor circuit to generate a reconstructed feature vector corresponding to an input feature vector representative of a video segment, the reconstructed feature vector based on a transformation applied to the input feature vector and an inverse of the transformation applied to an output of the transformation, the input feature vector and the reconstructed feature vector including features associated with a plurality of dimensions including a time dimension, generate an error vector based on a difference between the input feature vector and the reconstructed feature vector, and generate an anomaly map based on sums of elements of the error vector across at least the time dimension, the anomaly map corresponding to the video segment.

Example 9 includes the at least one non-transitory machine-readable medium of example 8, wherein the anomaly map indicates regions of interest in the video segment.

Example 10 includes the at least one non-transitory machine-readable medium of example 8, wherein the plurality of dimensions include a channel dimension, and the machine-readable instructions are to cause one or more of the at least one processor circuit to generate the anomaly map based on sums of the elements of the error vector across both the time dimension and the channel dimension.

Example 11 includes the at least one non-transitory machine-readable medium of example 10, wherein the plurality of dimensions include a height dimension and a width dimension, and the anomaly map includes entries associated with the height dimension and the width dimension.

Example 12 includes the at least one non-transitory machine-readable medium of example 8, wherein the transformation is based on a dimensionality reduction model.

Example 13 includes the at least one non-transitory machine-readable medium of example 12, wherein the dimensionality reduction model is based on Principal Component Analysis (PCA).

Example 14 includes the at least one non-transitory machine-readable medium of example 12, wherein the inverse of the transformation corresponds to an inverse of the dimensionality reduction model.

Example 15 includes a method comprising generating, by at least one processor circuit programmed by at least one instruction, a reconstructed feature vector corresponding to an input feature vector representative of a video segment, the reconstructed feature vector based on a transformation applied to the input feature vector and an inverse of the transformation applied to an output of the transformation, the input feature vector and the reconstructed feature vector including features associated with a plurality of dimensions including a time dimension, generating, by one or more of the at least one processor circuit, an error vector based on a difference between the input feature vector and the reconstructed feature vector, and generating, by one or more of the at least one processor circuit, an anomaly map based on sums of elements of the error vector across at least the time dimension, the anomaly map corresponding to the video segment.

Example 16 includes the method of example 15, wherein the anomaly map indicates regions of interest in the video segment.

Example 17 includes the method of example 15, wherein the plurality of dimensions include a channel dimension, and including generating the anomaly map based on sums of the elements of the error vector across both the time dimension and the channel dimension.

Example 18 includes the method of example 17, wherein the plurality of dimensions include a height dimension and a width dimension, and the anomaly map includes entries associated with the height dimension and the width dimension.

Example 19 includes the method of example 15, wherein the transformation is based on a dimensionality reduction model.

Example 20 includes the method of example 19, wherein the dimensionality reduction model is based on Principal Component Analysis (PCA).

Example 21 includes the method of example 19, wherein the inverse of the transformation corresponds to an inverse of the dimensionality reduction model.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
generate a reconstructed feature vector corresponding to an input feature vector representative of a video segment, the reconstructed feature vector based on a transformation applied to the input feature vector and an inverse of the transformation applied to an output of the transformation, the input feature vector and the reconstructed feature vector including features associated with a plurality of dimensions including a time dimension;
generate an error vector based on a difference between the input feature vector and the reconstructed feature vector; and
generate an anomaly map based on sums of elements of the error vector across at least the time dimension, the anomaly map corresponding to the video segment.

2. The apparatus of claim 1, wherein the anomaly map indicates regions of interest in the video segment.

3. The apparatus of claim 1, wherein the plurality of dimensions include a channel dimension, and one or more of the at least one processor circuit is to generate the anomaly map based on sums of the elements of the error vector across both the time dimension and the channel dimension.

4. The apparatus of claim 3, wherein the plurality of dimensions include a height dimension and a width dimension, the anomaly map including entries associated with the height dimension and the width dimension.

5. The apparatus of claim 1, wherein the transformation is based on a dimensionality reduction model.

6. The apparatus of claim 5, wherein the dimensionality reduction model is based on Principal Component Analysis (PCA).

7. The apparatus of claim 5, wherein the inverse of the transformation corresponds to an inverse of the dimensionality reduction model.

8. At least one non-transitory machine-readable medium comprising machine-readable instructions to cause at least one processor circuit to:
generate a reconstructed feature vector corresponding to an input feature vector representative of a video segment, the reconstructed feature vector based on a transformation applied to the input feature vector and an inverse of the transformation applied to an output of the transformation, the input feature vector and the reconstructed feature vector including features associated with a plurality of dimensions including a time dimension;
generate an error vector based on a difference between the input feature vector and the reconstructed feature vector; and
generate an anomaly map based on sums of elements of the error vector across at least the time dimension, the anomaly map corresponding to the video segment.

9. The at least one non-transitory machine-readable medium of claim 8, wherein the anomaly map indicates regions of interest in the video segment.

10. The at least one non-transitory machine-readable medium of claim 8, wherein the plurality of dimensions include a channel dimension, and the machine-readable instructions are to cause one or more of the at least one processor circuit to generate the anomaly map based on sums of the elements of the error vector across both the time dimension and the channel dimension.

11. The at least one non-transitory machine-readable medium of claim 10, wherein the plurality of dimensions include a height dimension and a width dimension, and the anomaly map includes entries associated with the height dimension and the width dimension.

12. The at least one non-transitory machine-readable medium of claim 8, wherein the transformation is based on a dimensionality reduction model.

13. The at least one non-transitory machine-readable medium of claim 12, wherein the dimensionality reduction model is based on Principal Component Analysis (PCA).

14. The at least one non-transitory machine-readable medium of claim 12, wherein the inverse of the transformation corresponds to an inverse of the dimensionality reduction model.

15. A method comprising:
generating, by at least one processor circuit programmed by at least one instruction, a reconstructed feature vector corresponding to an input feature vector representative of a video segment, the reconstructed feature vector based on a transformation applied to the input feature vector and an inverse of the transformation applied to an output of the transformation, the input feature vector and the reconstructed feature vector including features associated with a plurality of dimensions including a time dimension;
generating, by one or more of the at least one processor circuit, an error vector based on a difference between the input feature vector and the reconstructed feature vector; and
generating, by one or more of the at least one processor circuit, an anomaly map based on sums of elements of the error vector across at least the time dimension, the anomaly map corresponding to the video segment.

16. The method of claim 15, wherein the anomaly map indicates regions of interest in the video segment.

17. The method of claim 15, wherein the plurality of dimensions include a channel dimension, and including generating the anomaly map based on sums of the elements of the error vector across both the time dimension and the channel dimension.

18. The method of claim 17, wherein the plurality of dimensions include a height dimension and a width dimension, and the anomaly map includes entries associated with the height dimension and the width dimension.

19. The method of claim 15, wherein the transformation is based on a dimensionality reduction model.

20. The method of claim 19, wherein the dimensionality reduction model is based on Principal Component Analysis (PCA).
